(19) United States
(12) Patent Application Publication
(10) Pub. No.: US 2006/0245461 A1
(43) Pub. Date: Nov. 2, 2006

(54) Method and system for generating mid-infrared light

(75) Inventor: Mohammed N. Islam, Ann Arbor, MI (US)

Correspondence Address: BAKER BOTTS L.L.P., 2001 ROSS AVENUE, SUITE 600, DALLAS, TX, 75201-2980, US

(73) Assignee: Omni Services, Inc.

(21) Appl. No.: 11/335,997

(22) Filed: Jan. 20, 2006

Related U.S. Application Data
(60) Provisional application No. 60/646,193, filed on Jan. 21, 2005.

(51) Int. Cl. H01S 3/30; H01S 3/092; H01S 3/10; H01S 3/091; H01S 3/094

(52) U.S. Cl. 372/75; 372/6; 372/70; 372/20

(57) ABSTRACT

A mid-infrared light source comprises a pump laser, a fiber stage, and a waveguide stage. The pump laser generates light having an input wavelength between approximately one to two microns. The fiber stage comprises one or more intermediate fibers, and shifts at least a portion of the input wavelength to an intermediate wavelength longer than the input wavelength. The waveguide stage comprises one or more mid-infrared waveguides, and shifts at least a portion of the intermediate wavelength to yield mid-infrared light. The mid-infrared light has a spectrum, where at least a portion of the spectrum is approximately two microns or longer.

### RELATED APPLICATION

This application claims benefit under 35 U.S.C. § 119(e) of U.S. Provisional Application Ser. No. 60/646,193, entitled “LASER DIODE BASED MID-INFRARED LIGHT SOURCE AND USE IN BACKPAIN RELIEF,” Attorney's Docket 076196.0103, filed Jan. 21, 2005, by Mohammed N. Islam.

### GOVERNMENT FUNDING

The U.S. Government may have certain rights in this invention as provided for by the terms of Contract No. W911NF-04-C-0078 awarded by the Army Research Office of the U.S. Army.

### TECHNICAL FIELD

This invention relates generally to the field of light sources and more specifically to a method and system for generating mid-infrared light.

### BACKGROUND

Light sources may be used to introduce light into a body to perform a medical procedure in the body. As an example, light may be used to reduce the volume of nucleus pulposus in vertebra discs in order to relieve back pain. As another example, light may be used to perform laser ablation to create intracardiac lesions to treat tachycardias. As yet another example, light may be used to generate short ultrasonic or acoustic waves for ultrasound imaging.

In certain applications, specific wavelengths of light, such as mid-infrared wavelengths, may be selected. As an example, the wavelength may be selected such that light is absorbed by tissue, but does not initiate boiling in the tissue. As an example, the wavelength may be selected to generate specific acoustic waves. Known light sources generate mid-infrared light. These know light sources, however, are not effective or efficient in certain situations. It is generally desirable to have effective or efficient light sources in certain situations.

### SUMMARY OF THE DISCLOSURE

In accordance with the present invention, disadvantages and problems associated with previous techniques for generating mid-infrared light may be reduced or eliminated.

According to one embodiment of the present invention, a mid-infrared light source comprises a pump laser, a fiber stage, and a waveguide stage. The pump laser generates light having an input wavelength between approximately one to two microns. The fiber stage comprises one or more intermediate fibers, and shifts at least a portion of the input wavelength to an intermediate wavelength longer than the input wavelength. The waveguide stage comprises one or more mid-infrared waveguides, and shifts at least a portion of the intermediate wavelength to yield mid-infrared light. The mid-infrared light has a spectrum, where at least a portion of the spectrum is approximately two microns or longer.

Certain embodiments of the invention may provide one or more technical advantages. A technical advantage of one embodiment may be that mid-infrared light may be generated using a pump laser, a fiber stage, and a waveguide stage. Accordingly, mid-infrared light may be generated using a relatively simple arrangement of components.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram illustrating one embodiment of a mid-infrared light source operable to generate mid-infrared light;

FIG. 2 is a diagram illustrating example absorption coefficients for example wavelengths;

FIGS. 3A and 3B are diagrams illustrating example emission from a fused silica fiber that may be used with the light source of FIG. 1;

FIG. 4 is a diagram illustrating example emission from a calcogenide fiber that may be used with the light source of FIG. 1;

FIG. 5 is a block diagram illustrating an example embodiment of a mid-infrared light source operable to generate mid-infrared light;

FIG. 6 is a block diagram illustrating an example embodiment of a mid-infrared light source operable to generate mid-infrared light;

FIG. 7 is a diagram 150 illustrating an example of Raman wavelength shifting that may occur in the light source of FIG. 6;

FIG. 8 is a diagram illustrating efficiency estimated for an example of Raman wavelength shifting that may occur in the light source of FIG. 6;

FIG. 9 is a block diagram illustrating an example embodiment of a mid-infrared light source operable to generate mid-infrared light;

FIG. 10 is a diagram describing example Raman orders for the light source of FIG. 9;

FIG. 11 is a block diagram illustrating an example embodiment of a mid-infrared light source that includes a modulated pump laser that may control nonlinear fiber effects;

FIG. 12 is a block diagram illustrating one embodiment of a mid-infrared light source operable to generate mid-infrared light; and

FIG. 13 is a block diagram illustrating one embodiment of a fiber testing system operable to test mid-infrared fibers and other waveguides.

### DETAILED DESCRIPTION OF THE DRAWINGS

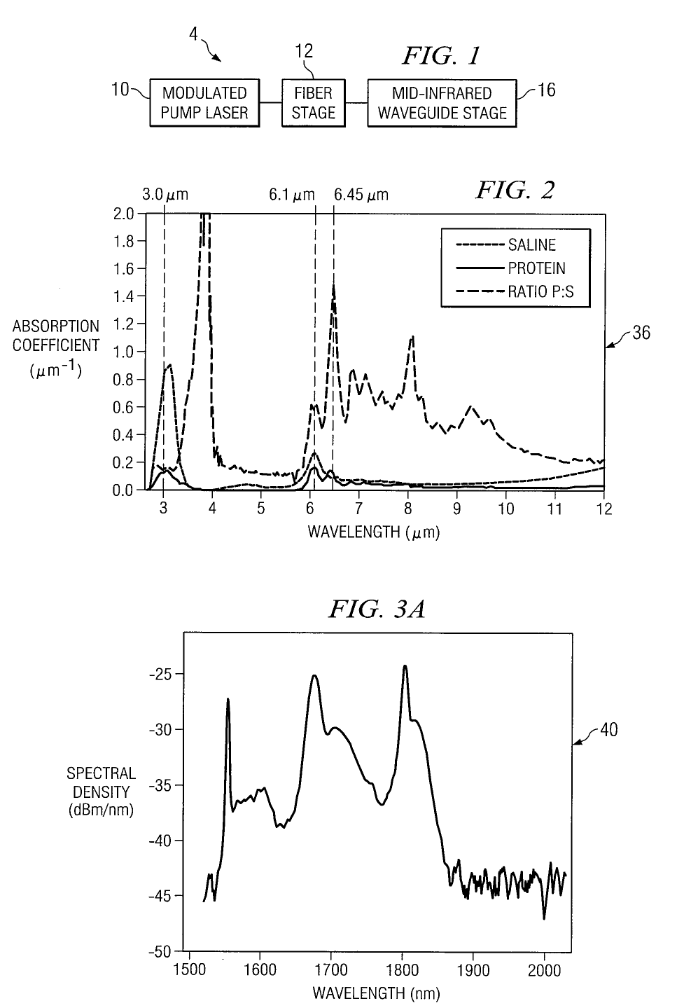

Embodiments of the present invention and its advantages are best understood by referring to FIGS. 1 through 13 of the drawings, like numerals being used for like and corresponding parts of the various drawings.

FIG. 1 is a block diagram illustrating one embodiment of a mid-infrared light source 4 operable to generate mid-infrared light. According to the illustrated embodiment, light source 4 includes a modulated pump laser 10, a fiber stage 12, and a mid-infrared waveguide stage 16 coupled as shown.

According to one embodiment of operation, modulated pump laser 10 generates light having an input wavelength. According to the embodiment, the light may have an input wavelength of approximately 1 to 2 microns. Fiber stage 12 shifts the input wavelength to an intermediate wavelength. According to the embodiment, the intermediate wavelength is longer than the input wavelength. Mid-infrared waveguide stage 16 shifts the intermediate wavelength to an output wavelength to generate mid-infrared light. According to the embodiment, the mid-infrared light may at least partially have an output wavelength of approximately 2 microns or longer.

Light source 4 may generate mid-infrared light by exploiting at least in part the Raman effect. Other nonlinear effects may be involved in the generation of mid-infrared light, such as self- or cross-phase modulation, four-wave mixing, parametric amplification, or modulational instability.

The Raman effect refers to the inelastic scattering of a photon, which creates or annihilates an optical photon. When light is scattered from an atom or molecule, most photons are elastically scattered, but a small fraction are inelastically scattered. The elastically scattered photons have the same energy (frequency) and thus wavelength as the incident photons. The inelastically scattered photons, however, are scattered at optical frequencies different from, and usually lower than, the frequency of the incident photons.

The Raman effect may be used to shift light to longer wavelengths. According to one embodiment, light enters a crystal lattice, such as an atomic lattice of a waveguide, creating optical phonons. The phonon energy corresponds to the energy shift between the pump light and the signal light for a single Raman order. The optical phonons then provide gain to longer wavelengths. The Raman process may be applied repeatedly to increase the wavelength. Raman wavelength shifting can operate over a wide range of parameters, such as wavelengths, pulse width, and repetition rate. The Raman effect is self-phase matched, and hence does not require tuning. Although the gain coefficient scales inversely with wavelength, the Raman effect is practically independent of wavelength.

According to the illustrated embodiment, modulated pump laser 10 generates pulsed light having an input wavelength. An input wavelength may refer to a wavelength that is shorter than a mid-infrared wavelength, and a mid-infrared wavelength may refer to a wavelength that is approximately 2 microns or more. As an example, the input wavelength may be between 1500 to 1600 nanometers (nm). The pulses may have any suitable temporal duration, such as approximately 10 picoseconds (psec) or approximately 100 psec or longer. The pulses may have any suitable repetition rate, such as from approximately a few hertz (Hz) to several hundreds of megahertz (MHz).

Fiber stage 12 shifts the wavelength of the light to an intermediate wavelength. An intermediate wavelength may refer to a wavelength that is longer than the input wavelength, but shorter than a mid-infrared wavelength. For example, the intermediate wavelength may be longer than the input wavelength, but less than approximately 2 microns, for example, between approximately 1.65 and 2.05 microns.

Fiber stage 12 may comprise one or more intermediate fibers. An intermediate fiber may refer to a fiber that may be shift the wavelength of the light to an intermediate wavelength. An example intermediate fiber may comprise a fused silica fiber, a high-nonlinearity fiber, an optical amplifier, an erbium-doped fiber, a photonic crystal fiber, a dispersion compensating fiber, a dispersion shifted fiber, a non-zero dispersion fiber, a dispersion flattened fiber, a patch-cord fiber, a low bend loss fiber, or any suitable combination of the preceding. In one example, a fused silica fiber may comprise a resonator with one or more fiber gratings.

In general, a fiber may be used in a open loop or in an oscillator. According to one embodiment, an oscillator may have optical gratings on one or both ends of the fiber. According to another embodiment, an oscillator may have mirrors, such as dielectric-coated broadband reflectors, on one or both ends of the fiber. An output coupler may partially transmit light of at least one desired output wavelength. A substrate of the output coupler may transmit light of at least some of the mid-infrared wavelength range. The fibers may be spliced together to optimize the dispersion profile and nonlinear effects.

Mid-infrared waveguide stage 16 shifts the wavelength of the light to a mid-infrared wavelength to generate mid-infrared light. According to one embodiment, the mid-infrared light may have an output wavelength of 2 microns or longer. Mid-infrared waveguide stage 16 may include one or more mid-infrared waveguides such as fibers. A mid-infrared fiber may refer to a fiber that shifts at least a portion of the wavelength of the light to a mid-infrared wavelength.

An exemplary mid-infrared waveguide may comprise a chalcogenide fiber, a fluoride fiber, a ZBLAN fiber (for example, a ZrF₄—BaF₂—LaF₃—AlF₃—NaF or other composition fiber), a chalcogenide glass waveguide, a tellurite glass waveguide, a silicon waveguide, a tellurite fiber, a semiconductor wafer, a semiconductor waveguide, other optical waveguide, or any combination of the preceding. A mid-infrared fiber may comprise at least a portion of a fiber used for optical amplification, such as fiber stage 12. In another embodiment, a mid-infrared fiber may comprise a hollow-core fiber or a capillary filled with nonlinear material.

Either the first stage fibers or the mid-infrared fibers may be selected to have a smaller effective area and a dispersion zero that can be shifted to a wider range of wavelengths. Furthermore, either the first stage fibers or the mid-infrared fibers may be selected to have, at least in some portions, anomalous group velocity dispersion at the wavelengths covered by the mid-infrared wavelengths or the input wavelengths.

The mid-infrared fibers may propagate light out to longer wavelengths than the first stage fibers. The mid-infrared fibers may be selected to have satisfactory propagation loss, for example, a propagation loss of less than approximately 5 decibels (dB) per meter (m) at about 3 microns or longer. Examples of such fibers include a fused silica fiber, a high-nonlinearity fiber (such as fibers that have an effective nonlinear coefficient γ>2 km⁻¹W⁻¹, γ>2.2 km⁻¹W⁻¹, or γ>3 km⁻¹W⁻¹), a dispersion shifted fiber, a non-zero dispersion fiber, a dispersion compensating fiber, a dispersion flattened fiber, a photonic crystal fiber, a fluoride fiber, a chalcogenide fiber, a semiconductor waveguide, a low bend loss fiber, an erbium doped fiber, or a tellurite fiber.

The mid-infrared waveguide may have any suitable core size, for example, approximately 30 microns or less, such as approximately 8 microns or less. The mid-infrared fiber may have any suitable length, for example, between 1 centimeter (cm) to 1 m to 100 kilometers (km), such as approximately 400 m. Propagating mid-infrared light through a fiber may lead to loss, so the length may be selected to remove the mid-infrared light substantially immediately after it is generated. For example, the length may be 50 m or less, 25 m or less, or 10 m or less.

Waveguides for propagating light in the mid-infrared range may comprise any suitable material. The features of the material affect the wavelength shift. A smaller phonon energy may allow for large transparency regions in the near-, mid- and far-infrared ranges. A greater Raman gain coefficient may yield a greater wavelength shift. In addition, the figure of merit for Raman wavelength shifting is proportional to the Raman gain coefficient divided by the fiber loss coefficient.

The mid-infrared material may comprise lattices of heavy atoms. As an example, the material may comprise chalcogenide glasses with sulfide (S), selenide (Se), or telluride (Te). For example, a chalcogenide glass may comprise one or more of the chalcogen elements S, Se, or Te with other elements such as germanium (Ge), arsenide (As), or antimony (Sb). In general, fused silica has low loss out to approximately 2 micrometers (μm), sulfide out to approximately 6 μm, selenide out to approximately 8.5 μm, and telluride out to approximately 11 μm.

As an example, an As—Se fiber may be used. The fiber may have a 7 μm core diameter and a numerical aperture of 0.45 at a wavelength of 1.56 μm. The peak of the Raman gain coefficient is approximately 700 times larger in As—Se chalcogenide fibers than in single-mode fused silica fibers. In addition, As—Se glass may have a much narrower Raman line (approximately 60 centimeter⁻¹ (cm⁻¹) than silica glass (approximately 250 cm⁻¹). Also, the Raman shift for As—Se glass may be smaller (approximately 240 cm⁻¹) than the Raman shift for silica fiber (approximately 440 cm⁻¹).

The As—Se fiber loss may be less than 1 dB/m over a wide range from approximately 1.5 to 9 μm. For the mid-infrared range between approximately 2 to 6.5 μm, the loss may be closer to 0.5 dB/m. There may be a loss peak near approximately 4.5 μm corresponding to a H—Se resonance. The loss peak may be reduced by modifying the composition of the glass. If the resonance of one fiber falls at a wavelength of interest, then another fiber with a different resonance may be used.

As another example, a sulfide fiber, such as an arsenic-tri-sulfide fiber, may be used. The peak Raman gain may be approximately 69 to 260 times larger for the sulfide fiber than for fused silica fiber. The peak of the Raman gain may be approximately 345 cm⁻¹, and the loss may be less than 1 dB over a wide range from approximately 1.2 to 4 microns. There may be a H—S peak in absorption around 4.1 microns.

As another example, a fluoride fiber, such as a heavy metal fluoride a ZBLAN fiber (for example, a ZrF₄—BaF₂—LaF₃—AlF₃—NaF or other composition fiber), may be used. Fluoride fiber may have a loss coefficient that may be more than two orders of magnitude lower than the loss coefficient for chalcogenide fibers over the wavelength range of approximately 2 to 5 μm. The Raman gain coefficient may be approximately 2 to 3 times larger than that for fused silica fiber. Moreover, the peak of the Raman gain falls at approximately 600 cm⁻¹.

The cascaded Raman wavelength shifting may continue in a fiber of sufficient length until the fiber loss becomes prohibitive. In the case of fused silica fibers, the loss may increase exponentially after 1.8 μm due to vibrational absorption. Therefore, after about 2 μm, mid-infrared fibers may be used. Fluoride fibers may be effective out to approximately 6 μm and chalcogenide fibers effective out to approximately 10 μm.

Light source 4 may operate in a pulsed or continuous wave manner. For pulsed operation, the peak powers may be sufficiently high to have efficient Raman wavelength shifting, even with open loop fibers. For continuous wave operation, the efficiency of the Raman process may be enhanced by using oscillators to multi-pass the pump and the various orders.

The spectrum of the light generated by light source 4 may selected such that at least a portion of the spectrum may be used for a particular application. According to one embodiment, wavelengths may be selected for use in tissue ablation. As an example, light source 4 may be used for percutaneous endoscopic laser discectomy, where the light is used to relieve back pain by reducing the volume of nucleus pulposus in vertebra discs. The wavelengths may be selected to optimize absorption of the light by the tissue. Moreover, wavelengths where the protein absorption exceeds the water absorption may be selected to reduce the risks from boiling water in the tissue. In general, protein absorption corresponds to the Amide I and Amide II resonances. Example wavelengths are described with reference to FIG. 2.

FIG. 2 is a diagram 36 illustrating example absorption coefficients for example wavelengths. Diagram 36 indicates wavelengths where the protein absorption exceeds the water absorption. In the example, wavelengths of approximately 3.5 to 6.5 microns, such as approximately 3.5 to 4 microns (for example, approximately 3.8 microns) or 6 to 6.5 microns (for example, approximately 6.45 microns) may be selected.

Referring back to FIG. 1, according to another embodiment, wavelengths may be selected for use in ultrasound imaging. Wavelengths of strong water absorption may be used to generate short ultrasonic or acoustic waves for high-resolution ultrasound imaging. As an example, wavelengths of 2.9 to 3.1 microns may be used. The water absorption is quite broad with numerous lines, however, so wavelengths in the range of 2.6 to 3.4 microns may also be used for photo-acoustic imaging.

One or more components of light source 4 may include appropriate input devices, output devices, processors, memory, or other components for receiving, processing, storing, and communicating information according to the operation of light source 4. As an example, one or more components of light source 4 may include logic, an interface, memory, other component, or any suitable combination of the preceding. “Logic” may refer to hardware, software, other logic, or any suitable combination of the preceding. Certain logic may manage the operation of a device, and may comprise, for example, a processor. “Processor” may refer to any suitable device operable to execute instructions and manipulate data to perform operations.

“Interface” may refer to logic of a device operable to receive input for the device, send output from the device, perform suitable processing of the input or output or both, or any combination of the preceding, and may comprise one or more ports, conversion software, or both. “Memory” may refer to logic operable to store and facilitate retrieval of information, and may comprise Random Access Memory (RAM), Read Only Memory (ROM), a magnetic drive, a disk drive, a Compact Disk (CD) drive, a Digital Video Disk (DVD) drive, removable media storage, any other suitable data storage medium, or a combination of any of the preceding.

Modifications, additions, or omissions may be made to light source 4 without departing from the scope of the invention. The components of light source 4 may be integrated or separated according to particular needs. Moreover, the operations of light source 4 may be performed by more, fewer, or other modules. Additionally, operations of light source 4 may be performed using any suitable logic.

Light source 4 may be used for any suitable application. According to one embodiment, light source 4 may enable minimally invasive medical procedures, where light enters the body through endoscopic devices or needles. The mid-infrared wavelengths may reduce the risks from heating associated with boiling water. As an example, light source 4 may be used for percutaneous endoscopic laser discectomy, where light is used to relieve back pain by reducing the volume of nucleus pulposus in vertebra discs.

As another example, light source 4 may be used for catheter ablation to treat tachycardias. The light may be fed through a fiber inserted in a catheter, and the catheter may be guided in the body with the aid of fluoroscopy. Then, laser ablation may be performed to create intracardiac lesions to treat the tachycardias. Using wavelengths where the protein absorption exceeds the water absorption may reduce collateral damage around the lesion. Moreover, the use of these wavelengths may yield cleaner lesions and reduce recurrences associated with changes in the lesion border zone.

As yet another example, light source 4 may be used for laser skin resurfacing or other area of cosmetic medical treatment. Laser skin resurfacing procedures use a laser to remove certain features of the skin, such as wrinkles. To resurface the skin, the laser is used to burn or cut away old skin cells, which in turn spurs on the growth of new cells and stimulates the production of collagen, a protein that is abundant in healthy skin. Ideally, in the process, red blotches, brown spots, and other kinds of discoloration are burned away; scars are rendered less prominent; and the skin is sufficiently plumped to smooth out rough patches and fine wrinkles.

The lasers that are traditionally used for this procedure, such as YAG lasers, carbon dioxide lasers, or erbium or erbium-YAG lasers, burn the skin by creating heating through water absorption. As a consequence, the use of these lasers may result in collateral damage. It may take one or two weeks for the skin to recover from the redness and swelling of this damage.

By using mid-infrared light source 4 at wavelengths where protein absorption dominates, such as between 3.5 to 4 microns or 6 to 6.5 microns, however, wrinkles may be cut away with reduced collateral damage, leading to a relatively rapid recovery from redness and swelling. In other words, the recovery from “cutting away” the protein by denaturing the protein may be more rapid than the recovery from damage resulting from “burning away” the protein.

According to another embodiment, light source 4 may be used for ultrasound imaging. Wavelengths of strong water absorption, for example, approximately 2.9 to 3.1 microns, may be used to generate a short ultrasonic or acoustic wave for high-resolution ultrasound imaging. The wavelengths of strong water may minimize the absorption length of mid-infrared light in the water. As an example, the pulse width may be less than 100 nanoseconds (ns), less than 10 ns, or less than 2 ns. For the short pulses and absorption lengths, the resulting wave may act as an acoustic impulse. In one particular embodiment, photo-acoustic generated impulses may be used to measure cornea thickness (pachymetry), for example, during planning for laser keratectomy.

FIGS. 3A and 3B are diagrams 40 and 44, respectively, illustrating example emission from a fused silica fiber that may be used with light source 4 of FIG. 1. Diagram 40 illustrates high intensity cascaded Raman wavelength shifting with two cascade Raman orders centered around 1680 nm and 1800 nm. Diagram 44 illustrates wavelength shifting from about 1800 nm to 2050 nm in a shorter length of dispersion shifted fiber.

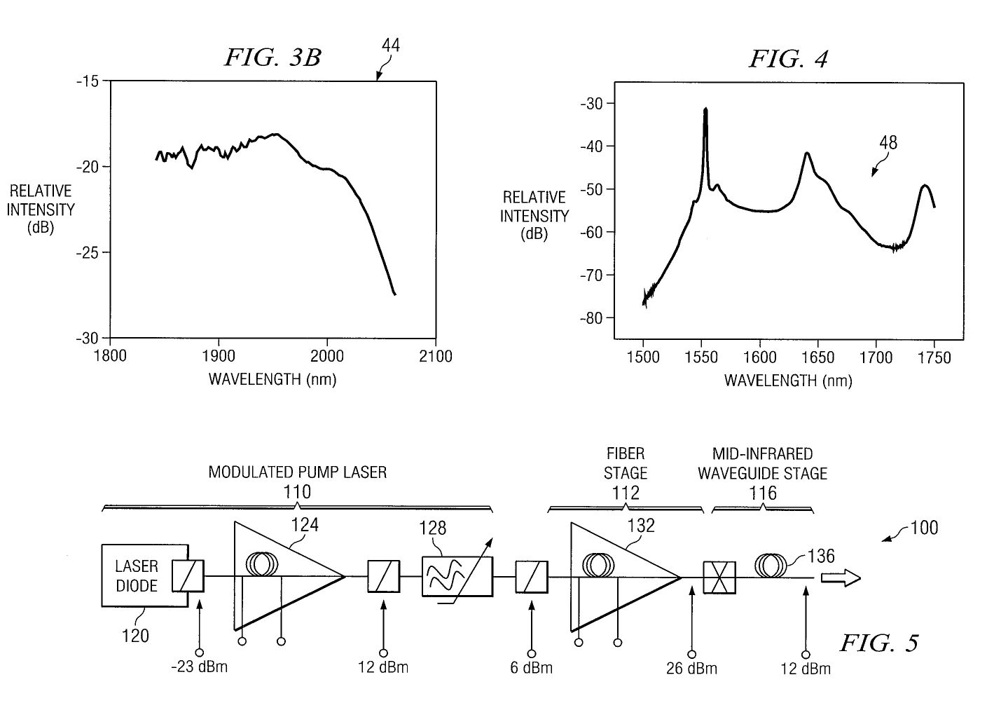

FIG. 4 is a diagram 48 illustrating example emission from a calcogenide fiber that may be used with light source 4 of FIG. 1. The calcogenide fiber may comprise, for example, 20 m of an arsenic-tri-sulfide fiber that has a slight selenide doping and a core size of approximately 6.5 microns. Diagram 48 shows the second order shift of two cascaded Raman order wavelength shifts.

FIG. 5 is a block diagram illustrating an example embodiment of a mid-infrared light source 100. According to the illustrated embodiment, light source 100 includes a modulated pump laser 110, a fiber stage 112, and a mid-infrared waveguide stage 116 coupled as shown.

According to the illustrated embodiment, modulated pump laser 110 includes one or more laser diodes 120, an optical amplifier 124, and a filter system 128. According to the embodiment, modulated pump laser 110 generates pulsed light. The light may have any suitable wavelength. For example, the wavelength may coincide with the gain peak of optical amplifier 124, which may be approximately 1532 nm. The pulses may have any suitable temporal duration, for example, approximately 15 ns, approximately 8 ns, or approximately 1.8 ns. The pulses may have any suitable repetition rate, for example, approximately 10 kilohertz (kHz) or approximately 5 kHz. Modulated pump laser 110 may comprise any suitable pump laser, such as a cladding-pumped fiber laser or a solid state laser.

According to one embodiment of operation, laser diodes 120 generate light, optical amplifier 124 increases the power of the light, and filter system 128 reduces or blocks unwanted features, such as amplified spontaneous emission (ASE).

Laser diode 120 may comprise any suitable diode operable to generate light, such as a pulsed distributed feedback laser diode (DFB-LD) or a Fabry-Perot laser diode. The light may have any suitable power, such as approximately −23 decibels referred to 1 milliwatt (dBm).

Optical amplifier 124 increases the power of light with any suitable gain, such as approximately a few decibels to hundreds of decibels, for example, approximately 30 to 60 dB. The noise figure need not be an important parameter for optical amplifier 124, so optical amplifier 124 may be selected to maximize efficiency.

Optical amplifier 124 may comprise any suitable optical amplifier. Example optical amplifiers include erbium-doped fiber amplifiers (EDFA), other rare earth doped fiber amplifiers, Raman amplifiers, optical parametric amplifiers, or semiconductor amplifiers. Optical amplifier 124 may have one or more stages. One or more filters, such as spectral or temporal filters, may be placed between or after stages to control the level of amplified spontaneous emission.

Filter system 128 reduces or blocks unwanted features, such as amplified spontaneous emission. Filter system 128 may comprise one or more wavelength filters and a temporal modulator that is synchronized with the light pulses. Filter system 128 may pass through the light with an insertion loss that reduces or blocks the unwanted features. The insertion loss may have any suitable value, such as approximately 6 dB, and may be passed through to high-power pre-amplifier 132. Filter system 128 may be placed at the input of the optical amplifier, at an intermediate location within the amplifier, or at the output of the optical amplifier.

Fiber stage 112 shifts at least a portion of the wavelength of the light to an intermediate wavelength. According to the illustrated embodiment, fiber stage 112 comprises a high-power amplifier 132 followed by a fiber pigtail made out of standard, single mode fused silica fiber. High-power amplifier 132 increases the power output of the light to a predetermined average power. The average power may have any suitable value, for example, approximately 26 dBm, which corresponds to a duty cycle of 830:1 for a peak power of approximately 300 watts (W), and a pulse energy of approximately 0.5 millijoules (mJ). In another particular embodiment, the duty cycle may be 100,000:1, and the peak power may be approximately 3 to 4 kW. High-power amplifier 132 may comprise any suitable optical amplifier, such as those described with reference to optical amplifier 124.

Mid-infrared waveguide stage 116 shifts at least a portion of the wavelength of the light to an output wavelength to generate mid-infrared light. According to the illustrated embodiment, mid-infrared waveguide stage 116 includes one or more fibers 136. Alternately, the mid-infrared waveguide stage 116 may comprise one or more waveguides, or a combination of fibers and waveguides. Fibers 136 may comprise one or more of any suitable mid-infrared fiber.

Modifications, additions, or omissions may be made to light source 100 without departing from the scope of the invention.

The components of light source 100 may be integrated or separated according to particular needs. Moreover, the operations of light source 100 may be performed by more, fewer, or other modules. Additionally, operations of light source 100 may be performed using any suitable logic. The components of light source 100 may be coupled using, for example, fiber slices or mechanical splices (such as butt-coupled fibers). Furthermore, light source 100 may include drive electronics for pulsing the pump laser and potentially for synchronizing any temporal filters to the pump pulses.

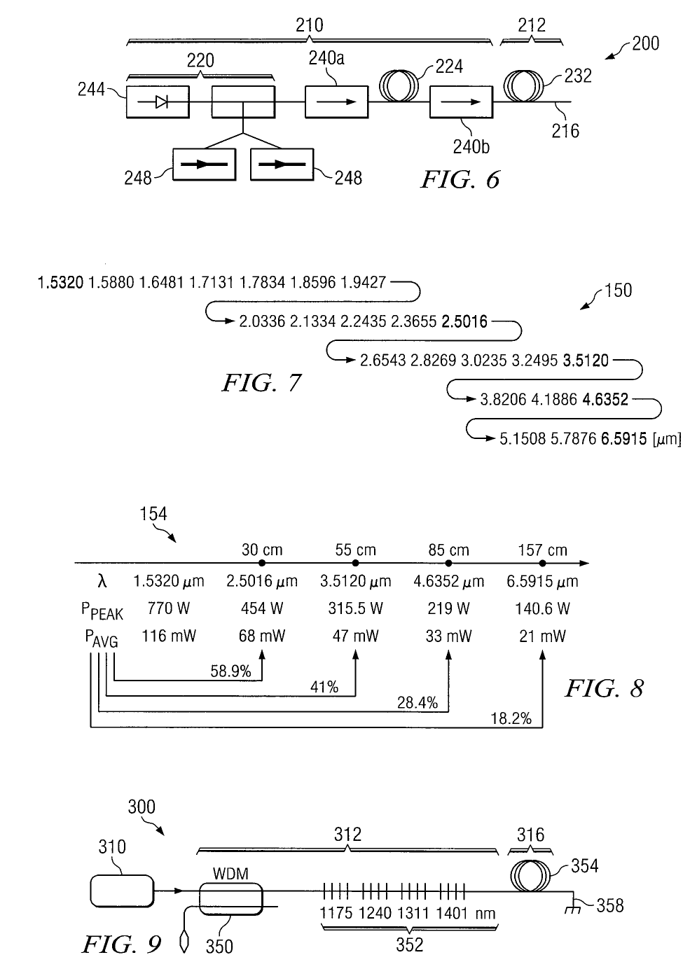

FIG. 6 is a block diagram illustrating an example embodiment of a mid-infrared light source 200. According to the illustrated embodiment, system 200 includes a modulated pump laser 210, a fiber stage 212, and a mid-infrared stage 216. Modulated pump laser 210 includes one or more laser diodes 220, isolators 240, and an optical amplifier 224.

Laser diodes 220 may include one or more modulated signal sources 244 and one or more pump lasers 248. A modulated signal source 244 generates pulsed light. The light may have any suitable wavelength, such as between 1500 to 1600 nm. For example, the wavelength may coincide with the gain peak of optical amplifier 124, which may be approximately 1532 nm. The pulses may have any suitable temporal duration, such as approximately 10 psec or approximately 100 psec or longer, for example, approximately 15 ns. The pulses may have any suitable repetition rate, such as approximately from a few hertz to several hundreds of megahertz, for example, approximately 5 kHz or approximately 10 kHz.

Pump laser 248 may comprise one or more polarization or wavelength multiplexed continuous wave lasers operating at any suitable wavelength, for example approximately 1480 nm or 980 nm. Pump laser 248 may have any suitable power, which may be selected with respect to the configuration and coupling loss between optical amplifier 224 and mid-infrared stage 216. For example, the power may be approximately 500 mW.

According to another embodiment, modulated signal source 244 may comprise a tunable laser that tunes over any suitable tuning range. For example, a conventional band (C-band) tunable laser diode tunes over approximately 1.53 to 1.57 μm. The tuning range of a tunable laser is proportional to the change in photon energy. Accordingly, a small or moderate wavelength tuning at approximately 1.5 μm yields large wavelength changes in the mid-infrared wavelength range. For example, a 40 nm energy tuning at a seed signal wavelength may yield approximately 100 nm tuning around 2.5 μm, approximately 220 nm tuning around 3.5 μm, and approximately 400 nm tuning around 4.6 μm.

Optical amplifier 224 may be substantially similar to optical amplifier 124 of FIG. 5. Isolators 240 may be used to prevent optical amplifiers 224 and 232 from lasing, which may result from reflected or Rayleigh scattered amplified spontaneous emission. According to one embodiment, a filter system substantially similar to filter system 128 may be used to reduce unwanted features such as amplified spontaneous emission.

In one embodiment fiber 212 includes optical amplifier 232, which may be substantially similar to optical amplifier 132 of FIG. 5. The output of optical amplifier 232 may have any suitable average power, for example, approximately 100 to 300 megawatts (mW). According to one embodiment, optical amplifiers 224 and 232 may have an upper state lifetime greater than 1 ns.

Mid-infrared stage 216 may be substantially similar to mid-infrared stage 116 of FIG. 5. According to one embodiment, mid-infrared stage 216 comprises a short mid-infrared fiber. According to one embodiment, the fiber core size may be increased for higher power applications. As an example, a larger fiber core size may be used for Raman shifting from a 1.532 μm pump out to 2.2 μm (2 W output), 3.4 μm (1 W output), and 5 μm (4 W output) with 10 ns pulses at 100 kHz repetition rate. In the example, the intensity may be maintained with a damage threshold of 2 GW/cm². Example fiber parameters are provided TABLE 1.

TABLE 1

| Output | Output | | Pump | Pump | | Fiber |
|---|---|---|---|---|---|---|
| wave- | average | Conversion | wave- | average | Fiber | core |
| length | power | efficiency | length | power | length | diameter |
| [μm] | [W] | [%] | [μm] | [W] | [cm] | [μm] |
| 2.24 | 2 | 65.8 | 1.532 | 3.03 | 24 | 13.9 |
| 3.40 | 1 | 41.4 | 1.517 | 2.41 | 62.5 | 12.4 |
| 5.00 | 4 | 21.8 | 1.532 | 18.34 | 150 | 34 |

Fibers with larger core sizes may be multiple mode fibers. For the lengths involved, a single spatial mode (that is, M²<1.4) may be maintained in a fiber by, for example, properly launching the light, avoiding twists and mode scrambling in the fiber, and/or utilizing mode-stripping at the termination point.

Light source 200 may be regarded as operating like a Q-switched laser. Optical amplifiers 224 and 232 may have a long upper state lifetime, approximately 10 ms. Accordingly, pump laser 248 may comprise continuous wave lasers, allowing for energy to build up between pulses. Modulated signal source 244 may be readily modulated, allowing the pulses to sweep out stored energy as they propagate through optical amplifiers 224 and 232. Accordingly, light source 200 may be regarded as operating like a Q-switched laser.

Modifications, additions, or omissions may be made to light source 200 without departing from the scope of the invention. The components of light source 200 may be integrated or separated according to particular needs. Moreover, the operations of light source 200 may be performed by more, fewer, or other modules. Additionally, operations of light source 200 may be performed using any suitable logic.

FIG. 7 is a diagram 150 illustrating an example of Raman wavelength shifting that may occur in system 200 of FIG. 6. According to diagram 150, the shifting starts from a seed wavelength of approximately 1.532 μm to approximately 2.5 μm, approximately 3.5 μm, approximately 4.6 μm, and approximately 6.6 μm. There are eleven Raman orders to shift from the seed wavelength to approximately 2.5 μm, five Raman orders to shift to approximately 3.5 μm, three Raman orders to shift to approximately 4.6 μm, and three orders to shift out to approximately 6.6 μm. Although this embodiment uses the Raman effect for wavelength shifting, other nonlinear effects, such as self-phase modulation, four-wave mixing, parametric amplification, or modulational instability could also be utilized to shift at least a portion of the wavelength to longer wavelengths.

Each order corresponds to a discrete phonon energy of 240 cm⁻¹. Accordingly, as the photon energy decreases at longer wavelengths, fewer energy steps are needed. Therefore, fewer orders are needed to shift to wavelengths longer than approximately 5 μm.

FIG. 8 is a diagram 154 illustrating efficiency estimated for an example of Raman wavelength shifting that may occur in light source 200 of FIG. 6. Coupled mode equations may be used to estimate the efficiency of a cascaded Raman process. For example, the following equations may be used:

$$\frac{ⅆ {P}_{p}}{ⅆ z} = \frac{{v}_{p}}{{v}_{s}} {gP}_{p} {P}_{s 1} - {α}_{p} {P}_{p} , \\ \frac{ⅆ {P}_{s 1}}{ⅆ z} = {gP}_{p} {P}_{s 1} - \frac{{v}_{s 1}}{{v}_{s 2}} {gP}_{s 1} {P}_{s 2} - {α}_{s 1} {P}_{s 1} …$$

$$\frac{ⅆ {P}_{sN}}{ⅆ z} = {gP}_{sN - 1} {P}_{sN} - {α}_{sN} {P}_{sN}$$

where each equation corresponds to a particular Raman order.

The left hand side terms describe propagation evolution. The first equation corresponds to the amplified seed wavelength, and the last equation corresponds to the final Raman order. The intermediate equation corresponds to intermediate Raman orders. The intermediate equation has three right hand side terms. The first term corresponds to gain from the previous order, the second term corresponds to loss to the next order, and the third term corresponds to attenuation due to fiber loss.

Assumptions may be made to estimate the efficiency. As a first example, the first wavelength may be given. As a second example, a spontaneous background power level may be assumed for the Raman cascade order wavelengths. The background power level may be assumed to correspond to one photon per mode over a bandwidth of approximately 10 cm⁻¹. As a third example, the fibers may be assumed to be selenide fibers. As a fourth example, the fibers length may be a few meters or less. Accordingly, the polarization mode scrambling may be assumed to be negligible, and the pump and signal wavelengths may be assumed to be co-polarized. The coupled mode equations may be solved by standard numerical integration techniques, such as the Runge-Kutta method, to estimate the efficiency.

Diagram 154 summarizes the efficiency and power for shifting of a seed wavelength of approximately 1.532 μm to approximately 2.5 μm, approximately 3.5 μm, approximately 4.6 μm, and approximately 6.6 μm in single-mode fiber with a 7 μm core diameter.

In this particular embodiment, the pump power into the mid-infrared fiber is assumed to be 2 gigawatt/centimeter² (GW/cm²), which is the experimentally measured damage threshold for selenide fibers used in pulsed operation. For the assumed 15 ns pulses and 10 KHz repetition rate, the pump power corresponds to a peak power of Pₚₑₐₖ=770 W and an average power of P_{avg}=116 mW at the beginning of the chalcogenide fiber. In a 30 cm length of fiber, the pump shifts out to 2.5016 μm with an efficiency of 58.9%, an output power of Pₚₑₐₖ=454 W, and an average power of P_{avg}=68 mW). In a 55 cm length of fiber, the pump shifts out to 3.512 μm with an efficiency of 41%, an output power of Pₚₑₐₖ=315.5 W, and an average power of P_{avg}=47 mW. Finally, in an 85 cm length of fiber, the pump shifts out to 4.6352 μm with an efficiency of 28.4%, an output power of Pₚₑₐₖ=219 W, and an average power of P_{avg}=33 mW.

In one example, the efficiency of the cascaded Raman shifting may be close to quantum efficiency, that is, the ratio of the photon energies, less any propagation loss in the fiber, which may be controlled by using shorter fibers. The efficiency for the longest wavelength may be degraded by the absorption peak near 4.5 μm in the particular example of selenide fibers. In addition, the photon energy may roll down to longer wavelengths as the light propagates down the fiber, depleting the energy from the previous order and then pumping the next order.

FIG. 9 is a block diagram illustrating an example embodiment of a mid-infrared light source 300. According to the illustrated embodiment, mid-infrared light source 300 includes a modulated pump laser 310, a fiber stage 312, and a mid-infrared stage 316.

Modulated pump laser 310 may comprise a continuous wave pump laser, such as solid state laser or a cladding pumped fiber laser. A continuous wave pump laser may have a low peak power, so resonators may be used to multi-pass the signal to increase efficiency. The input wavelength may be 1.06 microns or 1.94 microns. If the input wavelength is 1.94 microns, a fused silica Raman wavelength shifter may be omitted.

Fiber stage 312 may comprise a fiber 350 with a series of gratings 352. Gratings 352 can be formed directly into fiber 350 or spliced onto fiber 350. Gratings 352 may have a 99% reflectivity and a 2% loss per grating per pass. Each grating 352 may be tuned to each cascade order of the Raman process. To obtain multiple wavelength outputs, multiple gratings 352 may be used as output couplers. Mid-infrared stage 316 may comprise a Raman fiber 354 and a broadband reflector 358. The mid-infrared stage can be open loop (for example, single pass length of fiber), or it may be multi-passed in a resonator formed with one or more reflectors and/or one or more fiber gratings.

Modifications, additions, or omissions may be made to light source 300 without departing from the scope of the invention. For example, gratings 352 may be used on both sides of Raman fiber 354, with some gratings 352 transmitting the pump wavelength. Moreover, bulk optical components, such as high reflector mirrors or dichroic mirrors, may be used on both sides of Raman fiber 354. In addition, frequency selective elements, such as gratings, prisms, or birefringent plates may be used in the cavity.

The components of light source 300 may be integrated or separated according to particular needs. Moreover, the operations of light source 300 may be performed by more, fewer, or other modules. Additionally, operations of light source 300 may be performed using any suitable logic.

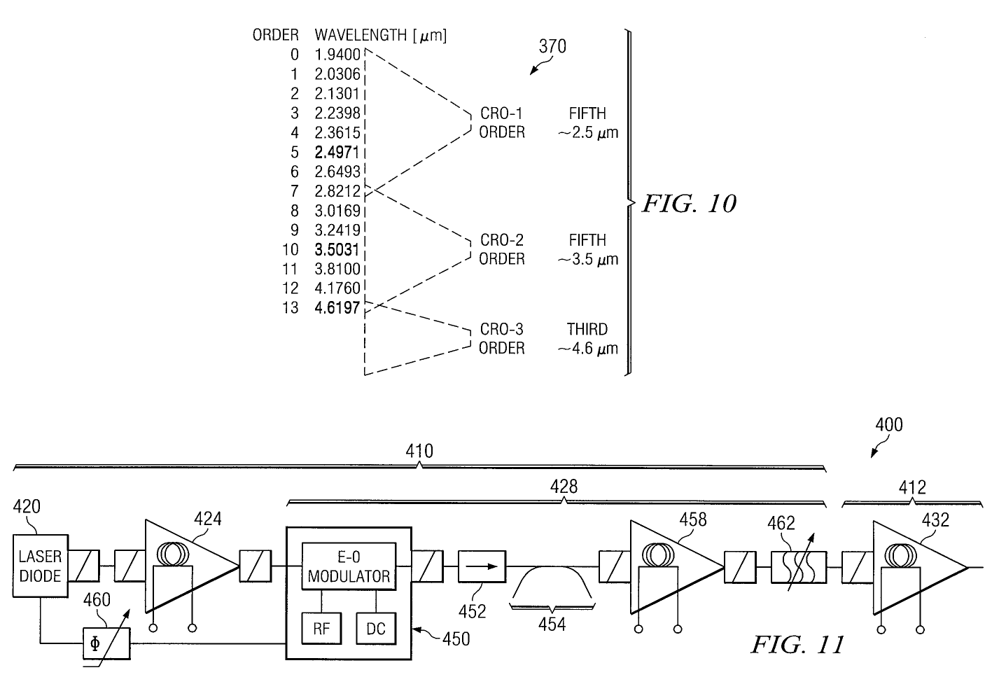

FIG. 10 is a diagram 370 describing example Raman orders for mid-infrared light source 300 of FIG. 9. According to one embodiment, a first cascaded Raman oscillator (CRO-1) shifts from an input wavelength of approximately 1.94 μm to 2.5 μm. CRO-1 may have a pump power of 27 W and an efficiency of 37% for a 10 W output. The output is used to pump a second CRO-2 to shift the light to approximately 3.5 μm. CRO-2 may have a pump power of 52 W and an efficiency of 19% for a 10 W output. The output of CRO-2 is used to pump a third CRO-3 to shift the light out to approximately 4.6 μm. CRO-3 may have a pump power of 95 W and an efficiency of 11% for a 10 W output. According to one embodiment, a portion of the output, such as 10 W, may be tapped at each wavelength, and the remaining light may be sent to the next oscillator. As this particular example illustrates, the mid-infrared light source may comprise more than just two stages following the pump. One of more of the stages may comprise fused silica fibers, and one or more of the stages may comprise mid-infrared waveguides.

FIG. 11 is a block diagram illustrating an example embodiment of mid-infrared light source 400 that includes a modulated pump laser 410 that may control nonlinear fiber effects within the pump laser portion. Nonlinear fiber effects, which may limit the useable power, may arise in the last stage power amplifier. Modulated pump laser 410 may control nonlinear fiber effects to yield peak powers of approximately 500 to 600 W or higher.

According to the illustrated embodiment, mid-infrared light source 400 includes modulated pump laser 410 and a fiber stage 412. Modulated pump laser 410 includes one or more laser diodes 420, an optical amplifier 424, and a filter system 428. Laser diodes 420 and optical amplifier 424 may be substantially similar to laser diodes 120 and optical amplifier 124, respectively, of FIG. 5.

According to the illustrated embodiment, filter system 428 includes a modulator 450, an isolator 452, taps 454, an optical amplifier 458, a tunable filter 462, and a variable delay 460. Modulator 450 blocks amplified spontaneous emission when laser diode 420 is off, which may at least reduce amplified spontaneous emission. Modulator 450 may comprise any suitable modulator, for example, a lithium niobate modulator. The window of modulator 450 may be synchronized to the laser drive of laser diode 420 to block the amplified spontaneous emission when a laser diode 420 is off. As an example, variable delay 460 such as a variable electrical delay line may be used to compensate for the delay to optical amplifier 424.

The selection of modulator 450 may be made according to any suitable factors. As an example, modulator 450 may be selected such that the on-off contrast ratio of modulator 450 can allow modulator 450 to be synchronized with the laser drive of laser diode 420. As another example, modulator 450 may be selected such that the insertion loss resulting from modulator 450 is acceptable.

Moreover, the placement of modulator 450 may be determined according to any suitable factors. As an example, modulator 450 may be placed to reduce insertion loss and noise. Although modulator 450 is illustrated as placed after optical amplifier 424, modulator 450 may be placed after optical amplifier 432 or after nonlinear waveguide 116 of FIG. 5. Furthermore, other devices may be used with modulator 450. As another example, a polarization controller may be placed prior to modulator 450 to control polarization.

Isolator 452 may be used to prevent feedback. Power tap 454 may be used to monitor the output of modulator 450. The output may indicate voltage drift of modulator 450 or polarization through modulator 450. Information from power tap 454 may be used to build a feedback loop to compensate for the voltage drift and to control polarization. Power tap 454 may comprise, for example, a 2% coupler.

Optical amplifier 458 may be used to compensate for losses resulting from modulator 450. Optical amplifier 458 may comprise, for example, a mid-stage (second stage), low noise, low power EDFA amplifier. Tunable spectral filter 462 may be used to limit out-of-band amplified spontaneous emission entering fiber stage 412. Tunable filter 462 may comprise, for example, a tunable spectral filter.

Fiber stage 412 comprises in this particular example an optical amplifier 432. Optical amplifier 432 may comprise, for example, a high power EDFA amplifier. Optical amplifier 432 may include any suitable components, such as couplers surrounding a gain fiber. For example, the couplers may comprise WDM couplers for coupling in and removing residual 980 nm pulses, and the gain fiber may comprise a highly-doped, large core, single spatial mode EDFA gain fiber. The gain fiber may be selected to minimize nonlinear limitations. For example, a high doping level may allow for use of a short fiber of approximately 1.5 to 2 m. A large core may allow for low intensity as consistent with a single spatial mode. The output of optical amplifier 432 may have an angled coupler, which may reduce reflections.

Optical amplifier 432 may include an isolator to reduce the reflection from the fibers. Optical amplifier 432 may output light having certain features. As an example, the spectrum may remain clean up to peak powers of 570 W and more, with reduced broadening on the long wavelength side.

Modifications, additions, or omissions may be made to light source 400 without departing from the scope of the invention. The components of light source 400 may be integrated or separated according to particular needs. Moreover, the operations of light source 400 may be performed by more, fewer, or other modules. Additionally, operations of light source 400 may be performed using any suitable logic.

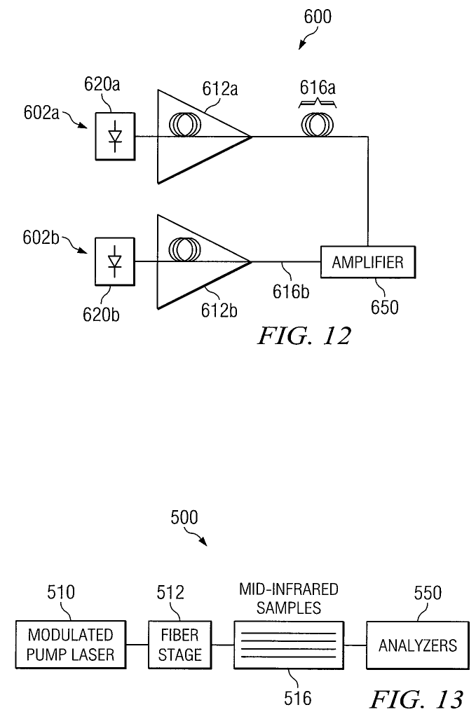

FIG. 12 is a block diagram illustrating one embodiment of a mid-infrared light source 600 operable to generate mid-infrared light. Light source 600 may be able to generate peak powers in the range of approximately 2 to 10 kW. According to the illustrated embodiment, light source 600 includes arms 602, each having a laser diode 620, a fiber stage 612, and a mid-infrared waveguide stage 616, and an optical parametric amplifier 650 coupled as shown.

Arm 602a represents a pump arm, and arm 602b represents a signal seed arm. Arm 602a generates a pump signal, and includes laser diode 620a, fiber stage 612, and mid-infrared stage 616. Laser diode 620a may comprise any suitable a laser diode, for example, Fabry-Perot or distributed Bragg reflector laser diode that generates light at approximately 1064 nm. Fiber stage 612 may comprise any suitable optical amplifier, for example, a single-mode fiber doped with yetterbium. Either or both laser diode 620a and 620b may be pulsed at, for example, approximately 1 to 2 ns. As an example, laser diode 620a and 620b may be synchronized to optimize gain.

Any suitable technique may be used to select the pulse width and pulse repetition rate for laser diode 620a. The width and rate may be selected in accordance with oscillators used to lower the threshold power for cascaded Raman wavelength shifting. As an example, the length of the pulses may be made longer than the transit time in an oscillator to emulate a quasi-CW pumping scheme. As another example, the pulse repetition rate might be made approximately equal to or a multiple of the inverse of the cavity transit time, yielding a synchronous pumping scheme. As another example, the pulse repetition rate may be adjusted so that there are several pump pulses per round-trip time in the oscillator. The signal in the oscillator may then experience gain for a plurality of pump pulses. There may be significant group velocity dispersion in mid-infrared fiber. The group velocity dispersion may be advantageous when several pump pulses are used, so that the signal can walk through the pump pulse to experience gain.

Mid-infrared stage 616 may comprise any suitable power amplifier, for example, a cladding-pumped, multi-mode yetterbium-doped fiber amplifier. The power amplifier may comprise a large core fiber that enables high power amplification while minimizing nonlinear effects. The light passing through the spatially multi-mode fiber may kept nearly single mode in any suitable manner. As an example, the mode may be launched using light mode-matched to the lowest order LP01 mode. As another example, bend-induced loss may be used to strip out higher order modes. As another example, the relatively short (several meters) portions of gain fiber may be gently bent to minimize mode mixing.

Arm 602b generates a seed signal, and includes laser diode 620b. Laser diode 620a may comprise any suitable laser diode or laser. For example, laser diode 620a may comprise a 1550 nm laser diode, such as a DBR, DFB, or Fabry-Perot laser diode, or may comprise a 1550 nm laser, such an erbium-doped fiber laser or a solid state laser, for example, a color center laser. The light from laser diode 620b may be pre-amplified in a single-mode, erbium-doped fiber.

Optical parametric amplifier 650 makes the pump and seed signals collinear, and amplifies the seed signal through a parametric amplification process. Optical parametric amplifier 650 may comprise a nonlinear crystal such as a periodically-poled lithium niobate crystal, lithium tantilate, KTP, or polymer materials. The crystal may have any suitable length, such as between several millimeters to several centimeters. The crystal may have any suitable features, such as waveguides to guide light. In another embodiment, the parametric amplification may occur in a mid-infrared fiber or other waveguide.

Modifications, additions, or omissions may be made to light source 600 without departing from the scope of the invention. The components of light source 600 may be integrated or separated according to particular needs. Moreover, the operations of light source 600 may be performed by more, fewer, or other modules. Additionally, operations of light source 600 may be performed using any suitable logic.

FIG. 13 is a block diagram illustrating one embodiment of a fiber testing system 500 operable to test mid-infrared fibers or other waveguides. According to the illustrated embodiment, fiber testing system 500 includes a modulated pump laser 510, a fiber stage 512, mid-infrared fiber or other waveguide samples 516, and one or more analyzers 550 coupled as shown. Modulated pump laser 510 and a fiber stage 512 may be substantially similar to modulated pump laser 10 and fiber stage 12, respectively, of FIG. 1.

Mid-infrared fiber or other waveguide samples 516 includes sample of fibers or other waveguides to be tested by fiber testing system 500. Fiber samples 516 may include any suitable fiber of any suitable composition and any suitable core size or length. For example, fiber samples 516 may include any of the fibers mentioned in this disclosure. Similarly, waveguide samples 516 may include any suitable waveguide of any suitable composition and any suitable core size or length, such as those waveguides mentioned in this disclosure.

Analyzers 500 detect and analyze light output from fiber samples 516. An analyzer 500 may comprise any suitable analyzer that may be optimized to detect near- to mid-infrared light. For example, an analyzer 500 may comprise an optical spectrum analyzer or an optical spectrometer, such as a 0.3 m spectrometer with a grating of 300 grooves per millimeter. Moreover, the analyzer 500 may include power meters and electronics as well as analysis computers and software.

An analyzer 500 may include any suitable detectors, analyzers, or other components for detecting and analyzing light, and any suitable procedure may be performed to detect and analyze light. As an example, a detector such as a modified InGaAs detector with sensitivity out to 2.6 microns may be used. Other examples of detectors include InAs, InSb, and HgCdTe detectors. As another example, lenses such as calcium fluoride lenses may be used to direct the light to a detector. As another example, a dry nitrogen may be used to purge the interior of a spectrometer to reduce the effect of the water absorption line.

According to one embodiment, the coupling of laser light into a chalcogenide fiber may be made more verifiable. In certain chalcogenide fibers, the transmission through the core of a fiber is only about 20% better than the transmission through the cladding of the fiber. Therefore, verifying that the light is coupled into the core may be difficult. According to one embodiment, a layer may be added to the input coupling end of the fiber to strip out the cladding modes, which may increase the contrast in transmission between the core and the cladding. As an example, a layer of gallium may be added to about 5 cm of the input coupling end.

One or more components of system 500 may include appropriate input devices, output devices, processors, memory, or other components for receiving, processing, storing, and communicating information according to the operation of system 500. As an example, one or more components of system 500 may include logic, an interface, memory, other component, or any suitable combination of the preceding.

Modifications, additions, or omissions may be made to system 500 without departing from the scope of the invention. The components of system 500 may be integrated or separated according to particular needs. Moreover, the operations of system 500 may be performed by more, fewer, or other modules. Additionally, operations of system 500 may be performed using any suitable logic.

Certain embodiments of the invention may provide one or more technical advantages. A technical advantage of one embodiment may be that mid-infrared light may be generated using a pump laser, a fiber stage, and a waveguide stage. Accordingly, mid-infrared light may be generated using a relatively simple arrangement of components.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure, as defined by the following claims.

What is claimed is:

1. A mid-infrared light source, comprising:
a pump laser operable to:
generate light having an input wavelength, the input wavelength between approximately one to two microns;
a fiber stage coupled to the pump laser, the fiber stage comprising one or more intermediate fibers, the fiber stage operable to:
shift at least a portion of the input wavelength to an intermediate wavelength, the intermediate wavelength longer than the input wavelength; and
a waveguide stage coupled to the fiber stage, the waveguide stage comprising one or more mid-infrared waveguides, the waveguide stage operable to:
shift at least a portion of the intermediate wavelength to yield mid-infrared light, the mid-infrared light having a spectrum, at least a portion of the spectrum being approximately two microns or longer.

2. The mid-infrared light source of claim 1, wherein the pump laser comprises:
one or more laser diodes coupled to an optical amplifier.

3. The mid-infrared light source of claim 1, wherein the pump laser comprises an amplifier selected from a group consisting of:
an erbium-doped fiber amplifier, a Raman amplifier, a semiconductor amplifier, an optical parametric amplifier, and a rare-earth doped fiber amplifier.

4. The mid-infrared light source of claim 1, wherein the pump laser comprises:
a filtering system operable to reduce amplified spontaneous emission.

5. The mid-infrared light source of claim 1, wherein the pump laser comprises:
a filtering system operable to reduce amplified spontaneous emission, the filtering system comprising:
one or more wavelength filters; and
at least one temporal modulator substantially synchronized with the pump laser.

6. The mid-infrared light source of claim 1, wherein the pump laser comprises a modulated pump laser operable to:
generate the light comprising a plurality of pulses having a repetition rate, the repetition rate between one hertz to 800 megahertz.

7. The mid-infrared light source of claim 1, wherein the pump laser comprises a modulated pump laser operable to:
generate the light comprising a plurality of pulses having a temporal duration, the temporal duration approximately 100 picoseconds or longer.

8. The mid-infrared light source of claim 1, wherein the pump laser comprises a laser selected from a group consisting of:
a cladding-pumped fiber laser and a solid state laser.

9. The mid-infrared light source of claim 1, wherein at least one intermediate fiber of the one or more intermediate fibers comprises:
a resonator having one or more fiber gratings.

10. The mid-infrared light source of claim 1, wherein at least one mid-infrared waveguide of the one or more mid-infrared waveguides is selected from a group consisting of:
a chalcogenide fiber, a fluoride fiber, and a ZBLAN fiber.

11. The mid-infrared light source of claim 1, wherein at least one mid-infrared waveguide of the one or more mid-infrared waveguides is selected from a group consisting of:
a chalcogenide glass waveguide, a tellurite glass waveguide, a silicon waveguide, a tellurite fiber, a semiconductor wafer, and a semiconductor waveguide.

12. The mid-infrared light source of claim 1, wherein at least one mid-infrared waveguide of the one or more mid-infrared waveguides has a core size of approximately 30 microns or less.

13. A mid-infrared light source comprising:
a pump laser operable to:
generate light having an input wavelength, the input wavelength between approximately one to two microns;
a fiber stage coupled to the pump laser, the fiber stage comprising one or more intermediate fibers, the fiber stage operable to:
shift at least a portion of the input wavelength to an intermediate wavelength, the intermediate wavelength longer than the input wavelength; and
a waveguide stage coupled to the fiber stage, the waveguide stage comprising one or more mid-infrared fibers with a propagation loss less than approximately five decibels per meter at approximately three microns, the waveguide stage operable to:
shift at least a portion of the intermediate wavelength to yield mid-infrared light, the mid-infrared light having a spectrum, at least a portion of the spectrum being approximately two microns or longer.

14. The mid-infrared light source of claim 13, wherein at least one mid-infrared fiber of the one or more mid-infrared fibers is selected from the group consisting of:
a chalcogenide fiber, a fluoride fiber, and a ZBLAN fiber.

15. The mid-infrared light source of claim 13, wherein at least the portion of the spectrum is approximately 2.9 to 6.5 microns.

16. The mid-infrared light source of claim 13, further comprising:
an output operable to direct the mid-infrared light towards a tissue, at least the portion of the spectrum of the mid-infrared light having a wavelength where a protein absorption of the tissue exceeds a water absorption of the tissue.

17. The mid-infrared light source of claim 13, further comprising:
an output operable to direct the mid-infrared light towards a tissue, at least the portion of the spectrum of the mid-infrared light having a wavelength operable to induce a plurality of ultrasonic waves to image the tissue.

18. A method for generating mid-infrared light, comprising:
generating light having an input wavelength, the input wavelength between approximately one to two microns, the light generated at a pump laser;
shifting at least a portion of the input wavelength to an intermediate wavelength, the intermediate wavelength longer than the input wavelength, the input wavelength shifted at a fiber stage, the fiber stage comprising one or more intermediate fibers; and
shifting at least a portion of the intermediate wavelength to yield mid-infrared light, the mid-infrared light having a spectrum, at least a portion of the spectrum being approximately two microns or longer, the intermediate wavelength shifted at a waveguide stage, the waveguide stage comprising one or more mid-infrared waveguides.

19. The method of claim 18, wherein at least one mid-infrared waveguide of the one or more mid-infrared waveguides is selected from a group consisting of:
a chalcogenide fiber, a fluoride fiber, and a ZBLAN fiber.

20. The method of claim 18, wherein generating light comprising the plurality of longer pulses further comprises:
amplifying light generated by one or more laser diodes; and
filtering the amplified light to reduce amplified spontaneous emission.
